(19) United States
(12) Patent Application Publication
(10) Pub. No.: US 2026/0066552 A1
(43) Pub. Date: Mar. 5, 2026

(54) Multi-Antenna HADM Boards with Antenna Signal Combiner

(71) Applicant: Silicon Laboratories Inc., Austin, TX (US)

(72) Inventors: Attila Zólomy, Budapest (HU); Szabolcs Lörincz, Budapest (HU); Levente Kovács, Budakalasz (HU); Pasi Rahikkala, Vihti (FI); Adam Süle, Budapest (HU)

(21) Appl. No.: 18/825,664

(22) Filed: Sep. 5, 2024

(51) Int. Cl. H01Q 21/29; H01P 5/22; H01Q 9/04

(52) U.S. Cl. CPC H01Q 21/29; H01P 5/227; H01Q 9/0414

(57) ABSTRACT

A system and method for performing distance measurements between two network devices is disclosed. The network device comprises two antenna elements, which may be oriented orthogonal with respect to one another. The outputs from these antenna elements are combined before being passed to the network interface for processing. The outputs may be combined using an active device or a passive device, such as a resistor network, a Wilkinson combiner or a 90° hybrid combiner. By orienting the antenna elements orthogonal to one another, the nulls associated with the radiation pattern of each do not overlap, reducing the error caused when signals are received at angles that correspond to the nulls of the antenna element.

Further, by combining the signals, the time and power needed to perform a distance measurement may be reduced.

### FIELD

This disclosure describes systems and methods for more accurately determining the distance between two wireless network devices, and specifically, using a new antenna configuration to perform the HADM procedure.

### BACKGROUND

The Bluetooth protocol has designed several techniques to implement high accuracy distance measurement (HADM). These include a phase based ranging approach and a round trip time approach. Typically, there are two devices associated with these approaches; an initiator device that initiates the distance measurement and a reflector device, which responds to the initiator device. The distance being measured is the distance between these two devices.

In the round trip time (RTT) approach, each device uses timestamps. Specifically, when a packet is transmitted, the transmitting device records a transmit timestamp. When that packet arrives, a receive timestamp is used by the receiving device.

In the phase based approach, the initiator device determines the incoming phase for signals transmitted at two different frequencies. The phase measured (θᵢₙᵢₜ) at the initiator device may be approximately the difference in phase between the two devices (i.e. Δθᵢᵣ), added to the product 2π*f*(tp), where f is the frequency of the transmitted signal and tp is the trip delay. If this phase is measured at two different frequencies, and the difference is taken, the result is (θᵢₙᵢₜ₁)−(θᵢₙᵢₜ₂)=2π*f1*(tp)−2π*f2*(tp), or 2*π*(f1−f2)*(tp). Based on this equation, the trip delay may be calculated and then converted to a distance.

The execution of either of these approaches to determine distance may be referred to as an HADM procedure. Both of these approaches assume that the phase and magnitude characteristics of the antenna elements are uniform, regardless of the angle of arrival and angle of departure of the incoming and outgoing signals. However, in reality, each antenna element has a unique radiation pattern, which is non uniform. This may result in various types of inaccuracies. For example, the phase response of the antenna may vary based on the angle of arrival. For example, most antenna radiation patterns may include a null. If the incoming signal arrives from the angle associated with the null, it may not be received, or its phase and/or magnitude may be significantly altered. These non-uniformities result may in distance inaccuracies.

One approach to address this problem is to install multiple antenna elements in the reflector device and the initiator device, each antenna element oriented differently so that the nulls do not align with one another.

Assume that there are 2 antenna elements on the initiator device and 2 antenna elements on the reflector device. Further, each device may also include an antenna switch that allows the selection of one of the 2 antenna elements for transmission or reception. To achieve a more accurate HADM result, the initiator device may choose to repeat the HADM procedure using each of its 2 antenna elements. Further, to also address issues associated with the antenna elements at the reflector device, the reflector device may choose to use each of its 2 antenna elements, to receive the signals. Thus, four HADM procedures may be performed using I1R1; I1R2; I2R1; and I2R2, wherein ImRn refers to the M^{th} antenna element of the initiator device and the N^{th} antenna element of the reflector device. Note that this number grows if there are more antenna elements. Specifically, Bluetooth allows up to 4 antennas on each device. If there are M antenna elements for the initiator device and N antenna elements for the reflector device, there are M×N possible HADM procedures that can be performed. Furthermore, the results of all of these HADM procedures must also be somehow combined in software to determine the actual distance between the initiator device and the reflector device. Note that this may consume a lot of power and time to complete.

Therefore, it would be beneficial if there was a system and method that was more accurate than a HADM procedure using single antenna and less power and time consuming than HADM procedures using multiple antenna elements.

### SUMMARY

A system and method for performing distance measurements between two network devices is disclosed. The network device comprises two antenna elements, which may be oriented orthogonal with respect to one another. The outputs from these antenna elements are combined before being passed to the network interface for processing. The outputs may be combined using an active device or a passive device, such as a resistor network, a Wilkinson combiner or a 90° hybrid combiner. By orienting the antenna elements orthogonal to one another, the nulls associated with the radiation pattern of each do not overlap, reducing the error caused when signals are received at angles that correspond to the nulls of the antenna element. Further, by combining the signals, the time and power needed to perform a distance measurement may be reduced.

According to one embodiment, a network device is disclosed. The network device comprises a processing unit; a memory device, in communication with the processing unit; a network interface; two antenna elements having different orientations with respect to each other; and a signal combiner in communication with each antenna element to combine signals from the two antenna elements and supply a combined signal to the network interface. In some embodiments, the two antenna elements are orthogonally oriented with respect to each other. In some embodiments, the two antenna elements are arranged such that the two antenna elements radiate from two orthogonal edges of a substrate. In some embodiments, the two antenna elements each have one or two or three orthogonal polarizations. In some embodiments, the two antenna elements are a same type of antenna. In some embodiments, the two antenna elements are each configured as inverted F antennas. In some embodiments, the signal combiner is a passive device. In certain embodiments, the signal combiner comprises a 90° hybrid combiner. In certain embodiments, the signal combiner comprises a Wilkinson combiner. In certain embodiments, the signal combiner comprises a resistor network. In some embodiments, the network device comprises at least a third antenna element oriented differently than the two antenna elements.

According to another embodiment, a method of determining a distance between two network devices is disclosed. The method comprises transmitting simultaneously a signal from a first device to a second device using two antenna elements; receiving a second signal from the second device, wherein the second signal is received at the first device using the two antenna elements; combining signals from the two antenna elements to create a combined signal; repeating the transmitting, receiving and combining at a plurality of frequencies; and using the combined signal received at the plurality of frequencies to determine a distance between the first device and the second device. In some embodiments, the two antenna elements are oriented orthogonal with respect to one another. In some embodiments, the two antenna elements are arranged such that the two antenna elements radiate from two orthogonal edges of a substrate. In some embodiments, the two antenna elements each have one or two or three orthogonal polarizations. In some embodiments, the two antenna elements are the same type of antenna. In some embodiments, the signals from the two antenna elements are combined using a passive device. In certain embodiments, the passive device comprises a 90° hybrid combiner. In certain embodiments, the passive device comprises a Wilkinson combiner. In certain embodiments, the passive device comprises a resistor network.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a representative initiator device that may estimate distance according to one embodiment;

FIGS. 2A-2C show three different embodiments of a signal combiner;

FIG. 3 shows a network having an initiator device and at least one reflector device according to one embodiment;

FIG. 4 shows the results of various tests when the reflector device is located 3 meters from the initiator device; and

FIG. 5 shows the results of various tests when the reflector device is located 11 meters from the initiator device.

### DETAILED DESCRIPTION

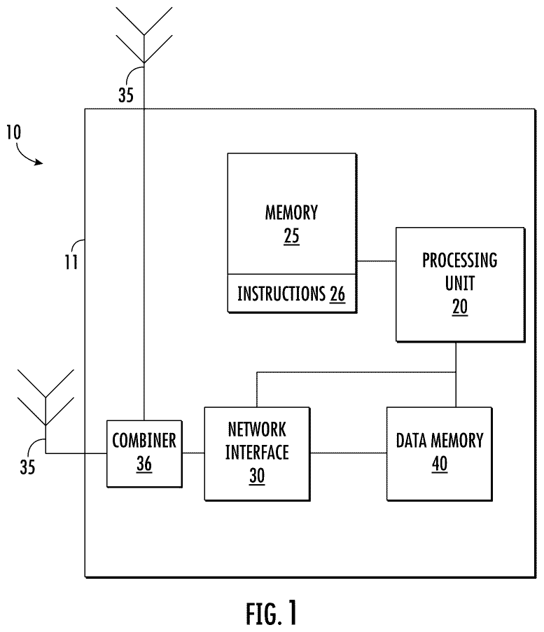

FIG. 1 shows a block diagram of a representative network device. This network device may serve as an initiator device 10, as described in more detail below. This network device may also be used to determine the distance to a remote device, also referred to as a reflector device.

The initiator device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the initiator device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

The initiator device 10 also includes a network interface 30, which may be a wireless interface including two antenna elements 35.

The wireless signals first enter the network interface 30 through two antenna elements 35. The signals from the two antenna elements 35 are combined using a signal combiner 36. The signal combiner 36 may be a bidirectional device which serves to combine two received signals into a combined signal that is supplied to the network interface 30. Additionally, the signal combiner 36 is also used to distribute a signal to be transmitted from the network interface 30 to both antenna elements 35. The signal combiner 36 may be any suitable active or passive device.

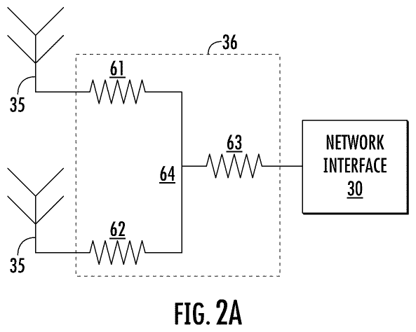

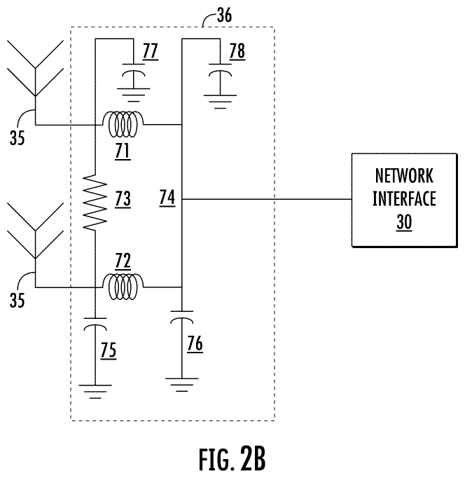

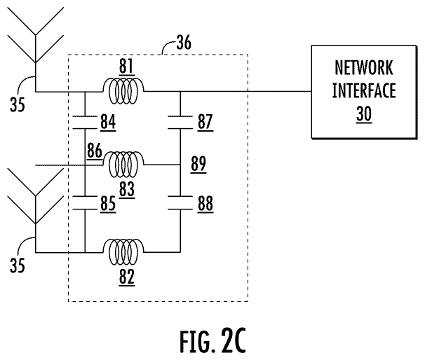

For example, the signal combiner may be a simple resistive network that combines the two signals using resistors 61, 62, 63, as shown in FIG. 2A. Resistor 61 is disposed between the common node 64 and the first antenna element, resistor 62 is disposed between the common node 64 and the second antenna element, while resistor 63 is disposed between the common node 64 and the network interface 30. In this configuration, the distance from the signal combiner 36 to each antenna element 35 may be the same so that the phase from each antenna element 35 is matched.

In another embodiment, the signal combiner 36 may be a Wilkinson combiner, as shown in FIG. 2B. The Wilkinson combiner includes inductors 71, 72, capacitors 75, 76, 77, 78 and resistor 73. The inductors 71, 72 are each disposed between their respective antenna element and the common node 74. The capacitors 75, 76, 77, 78 are each connected between an end of one of the inductors and the ground and, together with the inductors, form two PI networks between the respective antenna elements and the common node 74. The PI network is an artificial transmission line with roughly a 90° phase shift at the operating frequency range. In higher frequency embodiments, it may be replaced by a transmission line having a length equal to λ/4. The resistor 73 is disposed between the two antenna elements. The common node 74 is in communication with the network interface 30. In this configuration, the distance from the signal combiner 36 to each antenna element 35 may be the same so that the phase from each antenna element 35 is matched.

In another embodiment, the signal combiner 36 may be a 90° hybrid combiner, as shown in FIG. 2C. In this embodiment, a first inductor 81 is disposed between a first antenna element and the input node to the network interface 30. A first capacitor 84 is disposed between the first antenna element and a first common node 86. A second capacitor 85 is disposed between the second antenna element and the first common node 86. Additionally, a second inductor 82 and a fourth capacitor 88 are in series and are disposed between the second antenna element and a second common node 89. A third capacitor 87 is disposed the input node and the second common node 89. Finally, a third inductor 83 is disposed between the first common node 86 and the second common node 89. In this configuration, the distance from the signal combiner 36 to each antenna element 35 may be different to compensate for the 90° phase shift caused by the signal combiner 36. In higher frequency embodiments, a distributed element branch line hybrid may be used with a transmission line element having a length of λ/4 instead of the discrete hybrid realization.

In yet another embodiment, the signal combiner 36 may be an active device, such as a summing operational amplifier. In this embodiment, the input path and the output path may be separated, such as through the use of one or more analog multiplexers. The input path passes through the summing operational amplifier, while the output path bypasses the amplifier.

Returning to FIG. 1, the combined signal from the signal combiner 36 is in electrical communication with a low noise amplifier (LNA). The LNA receives a very weak signal from the signal combiner 36 and amplifies that signal while maintaining the signal-to-noise ratio (SNR) of the incoming signal. The amplified signal is then passed to a mixer. The mixer is also in communication with a local oscillator, which provides two phases to the mixer. The cosine of the frequency may be referred to as Iₒ, while the sin of the frequency may be referred to as Qₒ. The Iₒ signal is then multiplied by the incoming signal to create the inphase signal, Iₘ. The Qₒ signal is then multiplied by a 90° delayed version of the incoming signal to create the quadrature signal, Qₘ. The inphase signal, Iₘ, and the quadrature signal, Qₘ, from the mixer are then fed into programmable gain amplifier (PGA). The PGA amplifies the Iₘ and Qₘ signals by a programmable amount. These amplified signals may be referred to as I_{g} and Q_{g}. The amplified signals, I_{g} and Q_{g}, are then fed from the PGA into an analog to digital converter (ADC). The ADC converts these analog signals to digital signals, I_{d} and Q_{d}. These digital signals may then pass through a channel filter. The filtered signals are referred to as I and Q. These I and Q signals can be used to recreate the amplitude and phase of the original signal.

The network interface 30 may support any wireless network, such as Bluetooth, Wi-Fi, networks utilizing the IEEE 802.15.4 specification, such as Zigbee, networks utilizing the IEEE 802.15.6 specification, and wireless smart home protocols, such as Z-Wave. Thus, while much of the disclosure refers to Bluetooth, it is understood that the disclosed system and method can be used with any network protocol that supports HADM procedures. The network interface 30 is used to allow the initiator device to communicate with other devices disposed on the network.

The initiator device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the network. Although not shown, the initiator device 10 also has a power supply, which may be a battery or a connection to a permanent power source, such as a wall outlet.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions 26 may be written in any programming language and is not limited by this disclosure. Thus, in some embodiments, there may be multiple computer readable media that contain the instructions described herein. The first computer readable media may be in communication with the processing unit 20, as shown in FIG. 1. The second computer readable media may be a CDROM, or a different memory device, which is located remote from the initiator device 10. The instructions contained on this second computer readable media may be downloaded onto the memory device 25 to allow execution of the instructions by the initiator device 10.

While the processing unit 20, the memory device 25, the network interface 30, and the data memory device 40 are shown in FIG. 1 as separate components, it is understood that some or all of these components may be integrated into a single electronic component. Rather, FIG. 1 is used to illustrate the functionality of the initiator device 10, not its physical configuration.

Returning to FIG. 1, the initiator device 10 may be disposed on a printed circuit board or another substrate 11. The two antenna elements 35 may each have one polarization or two or three orthogonal polarizations. The two antenna elements may be an inverted F configuration, a monopole configuration, a ground loop configuration or another planar, stamped metal or wired antenna. The two antenna elements 35 may be the same type of antenna. The two antenna elements may have identical dimensions as well. In some embodiments, these two antenna elements may be arranged so that the two antenna elements radiate from orthogonal edges of the substrate 11. In this way, the radiation patterns of any received or transmitted signal differs between the two antenna elements. This arrangement allows the directions of the nulls of the two antenna elements to fall far from each other. This avoids reception of the direct path through pattern mulls of the two antenna elements. By disposing the antenna elements on orthogonal edges of the substrate, the antenna elements become orthogonally polarized, which minimizes the probability of cross-polarized reception. In other embodiments, the two antenna elements may be arranged on opposite edges of the substrate 11. While not orthogonally oriented, these two antenna elements 35 are still oriented differently, such as a 180° difference in orientation. This difference in orientation may reduce the possibility of signals being received through pattern nulls of both antenna elements. Note that in some embodiments, more than two antenna elements 35 may be disposed on the different edges of the substrate 11.

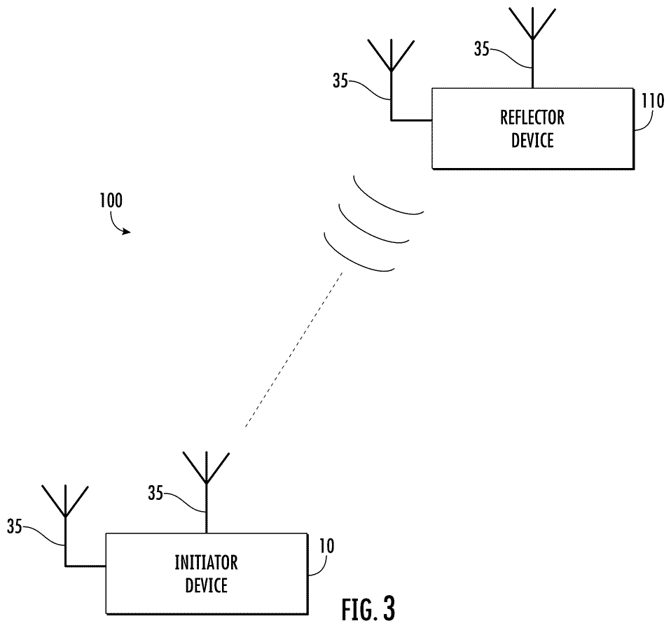

FIG. 3 shows a network 100 having at least one reflector device 110 and an initiator device 10. In certain embodiments, the reflector device 110 may be a network device and contain many of the components described above and shown in FIG. 1. Specifically, the reflector device 110 may comprise two antenna elements 35 and a signal combiner 36 as described above. However, the reflector device 110 may have a smaller amount of memory and may have less computational ability.

In FIG. 3, the initiator device 10 may transmit a signal, containing a sine wave having a first frequency to the reflector device 110. Because of the signal combiner 36, the signal is transmitted simultaneously on both antenna elements 35 by the initiator device 10. Further, the signals received by both of the antenna elements 35 at the reflector device 110 are combined. In response, the reflector device 110 may transmit a signal containing a sine wave having the same first frequency toward the initiator device 10. Again, because of the signal combiner 36, the signal is transmitted simultaneously on both antenna elements 35 by the reflector device 110. Further, the signals received by both of the antenna elements at the initiator device 10 are combined.

In certain embodiments, this signal is transmitted using a network protocol, such as Bluetooth.

The initiator device 10 may utilize the I and Q signals described above to determine the amplitude and phase of the signal arriving at the antenna elements 35. This information may then be used to calculate the distance from the initiator device 10 to the reflector device 110. This may be performed in a number of ways.

In one embodiment, the RTT approach described above may be performed. In another embodiment, the phase based approach may be performed using two or more different frequencies. Other methods may also be used.

Specifically, the Bluetooth specification describes a Channel Sounding procedure, during which the initiator device 10 transmits a first signal at a first frequency to the reflector device 110. The reflector device 110 measures the magnitude and phase of the incoming first signal. In response, the reflector device 110 transmits a second signal having the first frequency back to the initiator device 10. The initiator device 10 measures the magnitude and phase of the incoming second signal. This may be repeated for a number of different frequencies. Based on the magnitude and phase information gathered by the initiator device 10 and the reflector device 110, the channel transfer function (H) may be estimated. Note that the term “channel transfer function” is synonymous with “channel frequency response”.

As a specific example, the Bluetooth specification defines the following procedure to determine the channel transfer function.

First, θ_{CH}(f) represents the phase delay of the channel, where f is the channel frequency, and Δθ_{LO}(f) represents the relative difference in phase of the RF carrier between the initiator device and the reflector device. Based on this, the relative phases of a carrier measured at the reflector and initiator's antenna is θ_{REFL}(f)=θ_{CH}(f)+Δθ_{LO}(f) and θ_{INIT}(f)=θ_{CH}(f)−Δθ_{LO}(f). A_{REFL}(f) and A_{INIT}(f) represent the amplitude of that measured carrier at the reflector and initiator's antenna, respectively. Phase correction term (PCT) is defined by the angle that, if added to the internal angle of the local oscillator, would result in a phase identical to that of the incoming signal. The I and Q values represented by the PCT measured at the reflector and initiator, respectively, are given by PCT_{REFL}(f)=A_{REFL}(f)e^{iθ}_{REFL}(f) and PCT_{INIT}(f)=A_{INIT}(f)e^{iθ}_{INIT}(f). If the communication channel is symmetrical between the initiator device 10 and the reflector device 110, the measured phases are dependent on both the communication channel and the relative difference in phase of the RF carrier between the devices. The communication channel transfer function can then be estimated from

$${H}^{2} ( f ) = {A}_{REFL} ( f ) {e}_{REFL}^{i θ} ( f ) \times {A}_{INIT} ( f ) {e}_{INIT}^{i θ} ( f ) = {A}_{CH}^{2} ( f ) {e}_{CH}^{i 2 θ} ( f ) .$$

The channel transfer function (also referred to as channel frequency response) may then be used to compute the distance between the initiator device 10 and the reflector device 110. For example, the channel transfer function may be provided as an input to the MUSIC algorithm to determine the distance between the two devices, as is known in the art.

In each approach, the distance between the initiator device 10 and the reflector device 110 may be calculated.

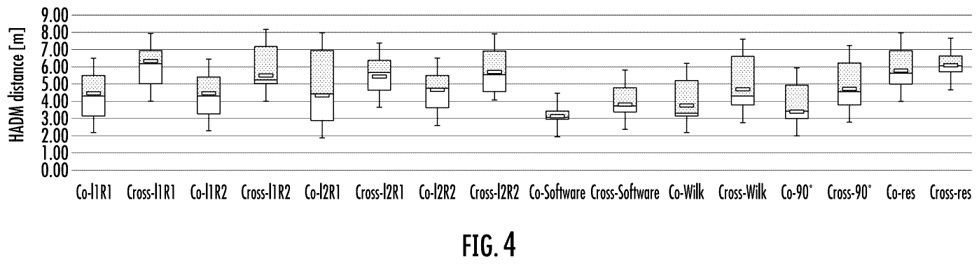

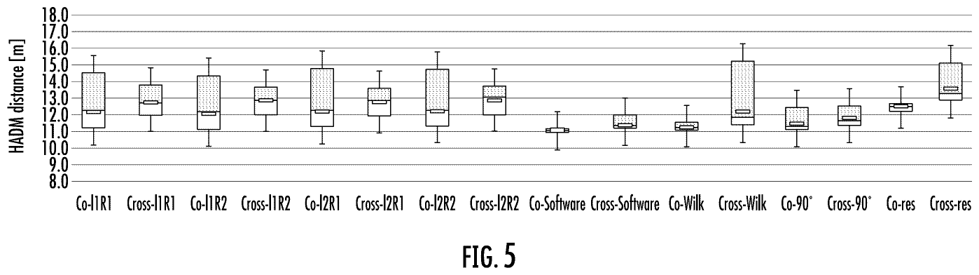

The present system has many advantages. By combining the signals so that they are transmitted and received by two antennas at different orientations, the effects of a non-uniform radiation pattern may be alleviated. Further, this approach is much less time and power consuming than the traditional approach of performing the HADM procedure N×M times, as described above. In addition, the combining of two antenna elements results in distance measurements that are typically more accurate that can be achieved using just a single antenna element on the initiator device 10 and the reflector device 110. FIGS. 4-5 show the results of actual testing.

In these tests, the reflector device was placed a known distance from the initiator device. Further, for each distance test, the reflector device was tested in two different orientations. In the first orientation, the reflector device was oriented in the same manner as the initiator device. For example, both may be laying horizontally on a table or other surface. This first orientation is referred to as the co-polarization orientation. In the second orientation, the reflector device was oriented orthogonally from the initiator device. For example, the initiator was laying horizontally on a table, while the reflector device was standing on end. This orientation is referred to as the cross-polarization orientation. The initiator device and the reflector device both include two planar antenna elements, which have one or two orthogonal polarizations parallel with the PCB plane and are disposed on orthogonal sides of the printed circuit board.

The reflector device is rotated in the plane of the table (i.e. in azimuth) with 45° steps. In each configuration and in each rotational position, the link was tested 50 times to generate an average value and the results are shown in FIGS. 4-5.

In FIG. 4, the reflector device was placed 3 meters from the initiator device. For the first portion of the test, the reflector device and the initiator device were operating in the conventional manner, where one antenna element on the initiator device transmitted to a single antenna element on the reflector device. Results were generated for each pairing of antenna elements. These results are shown in the leftmost eight columns of FIG. 4. Additionally, a combination result, which is generated by using the smallest distance from any of the 8 tests was calculated. These results are shown in the next two columns of FIG. 4.

The figure is a box and whisker graph, where the variation of the measured HADM distance represents the distance at the different azimuth positions during the rotation of the reflector device. The bottom whisker represents the minimum value; the bottom of the box represents the 20^{th} percentile, the top of the box represents the 80^{th} percentile, the top whisker represents the maximum value. Further, the box is divided into a lower box and a shaded upper box. The boundary between the lower box and the shaded upper box is the 50^{th} percentile or median. Finally, the bar within each box represents the average of the 20^{th} and 80^{th} percentiles.

The rightmost 6 columns represent the results using the different signal combiners 36 described above. In the eleventh and twelfth columns, the Wilkinson combiner of FIG. 2B was used. In the thirteenth and fourteenth columns, the 90° hybrid combiner of FIG. 2C was used. In the rightmost two columns the resistor network of FIG. 2A was used.

Note that for the leftmost eight columns, the difference between the 20^{th} percentile and the 80^{th} percentile was roughly 2 meters. Additionally, the median values for these eight columns was 4 meters or more. In fact, for four of these columns, the median value was greater than 5 meters. In contrast, the Wilkinson combiner and the 90° hybrid combiner both demonstrated better performance than the first 8 columns. Specifically, the median values for the Wilkinson combiner were about 3.1 and 4.2 meters, depending on orientation. Likewise, the median values for the 90° hybrid combiner were about 3.4 and 4.4 meters, depending on orientation.

The reflector device was then moved to a distance of 11 meters from the initiator device and the tests described above were repeated. These results are shown in FIG. 5. Note again that for the leftmost eight columns, the difference between the 20^{th} percentile and the 80^{th} percentile was between roughly 1.5 and 3 meters. Additionally, the median values for these eight columns was 12 meters or more. In contrast, for 4 of configurations in the rightmost 6 columns that utilized a signal combiner, the difference between the 20^{th} percentile and the 80^{th} percentile was 1 meter or less. Additionally, for 4 of configurations in the rightmost 6 columns, the median values was less than 12 meters.

Thus, these figures show that the use of a signal combiner produces more accurate results than the use of one antenna at each device. Additionally, the spreading (i.e. difference between maximum and minimum values) is also reduced compared to most of the single antenna cases. Further, while the results are not as accurate as the software approach, where results from all four tests are combined to determine the distance, the method that uses the signal combiner is much quicker, uses less expensive hardware and consumes much lower power.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A network device, comprising:
a processing unit;
a memory device, in communication with the processing unit;
a network interface;
two antenna elements having different orientations with respect to each other; and
a signal combiner in communication with each antenna element to combine signals from the two antenna elements and supply a combined signal to the network interface.

2. The network device of claim 1, wherein the two antenna elements are orthogonally oriented with respect to each other.

3. The network device of claim 2, wherein the two antenna elements are arranged such that the two antenna elements radiate from two orthogonal edges of a substrate.

4. The network device of claim 1, wherein the two antenna elements each have one or two or three orthogonal polarizations.

5. The network device of claim 1, wherein the two antenna elements are a same type of antenna.

6. The network device of claim 5, wherein the two antenna elements are each configured as inverted F antennas.

7. The network device of claim 1, wherein the signal combiner is a passive device.

8. The network device of claim 7, wherein the signal combiner comprises a 90° hybrid combiner.

9. The network device of claim 7, wherein the signal combiner comprises a Wilkinson combiner.

10. The network device of claim 7, wherein the signal combiner comprises a resistor network.

11. The network device of claim 1, further comprising at least a third antenna element oriented differently than the two antenna elements.

12. A method of determining a distance between two network devices, comprising:
transmitting simultaneously a signal from a first device to a second device using two antenna elements;
receiving a second signal from the second device, wherein the second signal is received at the first device using the two antenna elements;
combining signals from the two antenna elements to create a combined signal;
repeating the transmitting, receiving and combining at a plurality of frequencies; and
using the combined signal received at the plurality of frequencies to determine a distance between the first device and the second device.

13. The method of claim 12, wherein the two antenna elements are oriented orthogonal with respect to one another.

14. The method of claim 13, wherein the two antenna elements are arranged such that the two antenna elements radiate from two orthogonal edges of a substrate.

15. The method of claim 12, wherein the two antenna elements each have one or two or three orthogonal polarizations.

16. The method of claim 12, wherein the two antenna elements are the same type of antenna.

17. The method of claim 12, wherein the signals from the two antenna elements are combined using a passive device.

18. The method of claim 17, wherein the passive device comprises a 90° hybrid combiner.

19. The method of claim 17, wherein the passive device comprises a Wilkinson combiner.

20. The method of claim 17, wherein the passive device comprises a resistor network.
